(19) United States
(12) Patent Application Publication
(10) Pub. No.: US 2016/0326853 A1
(43) Pub. Date: Nov. 10, 2016

(54) MULTIPLE WELLBORE PERFORATION AND STIMULATION

(71) Applicant: Schlumberger Technology Corporation, Sugar Land, TX (US)

(72) Inventors: Christopher Fredd, Westfield, NY (US); Jean Desroches, La Defense Cedex (FR)

(21) Appl. No.: 14/707,223

(22) Filed: May 8, 2015

(51) Int. Cl. E21B 43/26; G06F 17/50; E21B 49/00; G06F 17/11; E21B 43/16; E21B 43/116

(52) U.S. Cl. CPC E21B 43/26; E21B 43/16; E21B 43/116; E21B 49/00; G06F 17/11; G06F 17/5009

(57) ABSTRACT

A method of treating a subterranean formation includes providing a plurality of cased wellbores penetrating a subterranean formation, where the plurality of cased wellbores is fluidly connected with a common treatment fluid source. Flow-through passages are then formed at a first zone within each wellbore of the plurality of cased wellbores, and the subterranean formation is treated by pumping a treatment fluid through the flow-through passages formed in the plurality of cased wellbores at a pressure sufficient to treat the subterranean formation. In some cases, the flow-through passages are a cluster of perforations. A fluid pressurizing system may be disposed between each of the wellbores and the common treatment fluid source.

### FIELD

The field to which the disclosure generally relates to is stimulation operations conducted through a wellbore to improve the flow of production fluid from a surrounding formation into the wellbore, and in particular multi-stage multiple wellbore stimulation for enhancing fluid production from the surrounding formation.

### BACKGROUND

This section provides background information to facilitate a better understanding of the various aspects of the disclosure. It should be understood that the statements in this section of this document are to be read in this light, and not as admissions of prior art.

Hydrocarbon exploration and production, as well as other subterranean activities (e.g., water exploration and extraction), involve drilling and completing a wellbore. The wellbore is drilled into the ground and then can be lined with metal pipe generally referred to as casing. The casing can extend essentially the entire length of the wellbore or terminate short of the total depth thereby leaving an uncased, open hole, portion of the well. The casing may also be cemented in place, sealing the annulus between the casing and the earthen formation.

Such subterranean activities are generally complicated, time consuming and ultimately very expensive endeavors. In recognition of these expenses, added emphasis has been placed on efficiencies associated with well completions and maintenance over the life of the well. Over the years, ever increasing well depths and sophisticated architecture have made reductions in time and effort spent in completions and maintenance operations of even greater focus.

Well stimulating applications that include perforating a cased well and fracturing the surrounding formation during completions constitute one such area where significant amounts of time and effort are spent. This is particularly the case where increases in well depths and sophisticated architecture are encountered. Once the casing hardware is cemented in place, stimulating applications generally take place in a zone by zone fashion. For example, a terminal end of the well may be perforated and fractured followed by setting of a plug immediately uphole thereof. Thus, with the lower most zone initially stimulated, the zone above the plug may now also be stimulated by way of repeating the perforating and fracturing applications. This time consuming sequence of plug setting, perforating and then fracturing is repeated for each zone. That is, likely up to 20 zones or more of a given well may be stimulated in this manner. Further, for any given zone, each step of plug setting, perforating and fracturing requires its own dedicated application trip into the well via wireline from surface or other appropriate conveyance. Ultimately, once each zone has been stimulated, the well is left with twenty or so isolated zones. Thus, a milling application may ensue where a milling tool is dropped through the well which mills out all of the plugs. As such, flow through the central bore of the well may be restored. Unlike the previous steps, at least the milling may take place through each zone with only one trip into the well with the milling tool.

As can be appreciated, such methods of treating multiple zones in separate trips can be highly involved, time consuming and costly. Other methods of treating multiple zones within a subterranean formation have been conducted to reduce these time and cost requirements. These multi-stage fracturing operations often involve simultaneously fracturing several perforation clusters to achieve multiple hydraulic fractures in a single fluid pumping stage. This approach improves the time efficiency, as several fracture operation designs are pumped at the same time at a pump rate equivalent to the sum required for each of the individual fracture per cluster. However, multi-stage fracturing techniques suffer from one or more drawbacks, such as difficulty in controlling fracture placement, long cycle times between stages (e.g. to run tools into the hole), and/or limitations on treatment execution such as the order of treating several intervals of a subterranean formation successively. Further, multi-stage fracturing can be highly ineffective, as 30 to 50% of the perforation clusters sometimes are not properly fractured and subsequently do not contribute to production. For example, it is common in one stage to pump fracturing fluid at a rate of 100 barrels per minute into five perforation clusters simultaneously which may result in not all perforation clusters properly opened. The ineffective nature of multiple clusters per stage is illustrated in SPE 173363 (included herein by reference), where one cluster gives 100% effectiveness, two clusters drops to 39%, and effectiveness continues to decrease with increasing number of clusters with only 23% effectiveness with 6 clusters. Hence, it is advantageous to treat only one cluster at a time to maximize effectiveness, but there is also a need to treat multiple clusters simultaneously to enhance efficiency.

Thus, where stimulating operations are involved, the operator is likely faced with days' worth of time dedicated to the task. In today's dollars this may translate into significant expense due to lost production time. Thus, there is a need for improved multi-stage wellbore treatment methods which improve over the above described problems, and such need is addressed, at least in part, by embodiments described in the following disclosure.

### SUMMARY

This section provides a general summary of the disclosure, and is not a necessarily a comprehensive disclosure of its full scope or all of its features.

In a first aspect of the disclosure, a method of treating a subterranean formation includes providing a plurality of cased wellbores penetrating a subterranean formation, where the plurality of cased wellbores are fluidly connected with a common treatment fluid source. Flow-through passages are then formed at a first zone within each wellbore of the plurality of cased wellbores, and the subterranean formation is treated by pumping a treatment fluid through the flow-through passages formed in the plurality of cased wellbores at a pressure sufficient to treat the subterranean formation. In some cases, the flow-through passages are a cluster of perforations. The flow-through passages may be formed by any suitable technique, such as a perforating gun or fluid jetting or multistage completion ports. A fluid pressurizing system may be disposed between each of the wellbores and the common treatment fluid source. Also, each of the wellbores may be fluidly connected with a dedicated fluid pressurizing system delivering treatment fluid from the common treatment fluid source to the wellbore at a select fluid pressure.

In some cases, the pressure of the treatment fluid in each wellbore is equal to or greater than the fracture initiation pressure of the subterranean formation surrounding each of the plurality of cased wellbores, and the treating is conducted in a well drilled in the direction perpendicular to a principal stress of the subterranean formation surrounding each wellbore comprised in the plurality of cased wellbores. The treating may also be conducted in a well drilled in the direction aligned with or in a plane parallel to a direction of a principal stress of the subterranean formation surrounding each wellbore of the plurality of wellbores.

Second flow-through passages may be formed at a second zone within each wellbore of the plurality of cased wellbores and the subterranean formation treated by pumping the treatment fluid through the second flow-through passages formed at the second zone at a pressure sufficient the treat the subterranean formation. This may be repeated as many times as required to achieve the overall formation treatment, by forming up to Nth flow-through passages at an Nth zone within each wellbore and treating the subterranean formation by pumping the treatment fluid through the Nth flow-through passages formed at the Nth zone.

In some instances, modeling may be conducted in conjunction with the treatment. Some modeling steps may include acquiring subterranean formation layer geomechanical properties from well completion and reservoir data for the subterranean formation, and a natural fracture network description for the subterranean formation. Then geomechanical properties of the subterranean formation inputted into a model, propagation of a network of fractures in the subterranean formation simulated, prediction of whether each fracture will grow and in which direction the fracture will branch, and then predicting a flow rate and pressure distribution throughout the network of fractures by solving governing deformation and flow equations. A result of the design for the treating the subterranean formation is then made, the treatment carried out, and adjustment to the treatment design made if the result is not satisfactory.

Another modeling scheme may be used where elasticity properties are inputted into a model for each of subterranean formation surrounding each wellbore of the plurality of wellbores. Then propagation of a network of fractures in the subterranean formation simulated, prediction of whether each fracture will grow and in which direction the fracture will branch, and then predicting a flow rate and pressure distribution throughout the network of fractures by solving governing deformation and flow equations. An optimum treatment fluid may be prepared to achieve simulated fracturing result, and the treatment operation is carried out.

In another aspect, a method of fracturing a subterranean formation is disclosed where a plurality of cased wellbores penetrating a subterranean formation is provided, and the plurality of cased wellbores are fluidly connected with a common fracturing fluid source. A first cluster of perforations may be formed at a first zone within each wellbore making up the plurality of cased wellbores, and the subterranean formation is fractured by simultaneously pumping a fracturing fluid through the first cluster of perforations at a pressure sufficient to fracture the subterranean formation adjacent each wellbore. This can be repeated at second zone within each of the wellbores by forming a second cluster of perforations at a second zone within each wellbore of the plurality of cased wellbores, and, then the subterranean formation fractured by simultaneously pumping the fracturing fluid through the second cluster of perforations. This may be further repeated, as many times as required, by forming up to cluster of perforations at a Nth zone within each wellbore and fracturing the subterranean formation by simultaneously pumping the treatment fluid through the Nth flow-through passages.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 illustrates an arrangement of surface equipment components and multiple wellbores useful for stimulating a subterranean formation in an essentially simultaneous or alternating manner through the wellbores, in accordance with an aspect of the disclosure;

FIGS. 2A-2D depicts how a treatment method according to the disclosure may be conducted in accordance with the disclosure, in a cross section view;

FIGS. 3A-3D depicts how another treatment method according to the disclosure may be conducted in accordance with the disclosure, in a cross section view; and,

FIGS. 4A-4C illustrate some examples of the order of forming flow-through passages and conducting subterranean formation treatment, in accordance with the disclosure, in a cross section view.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

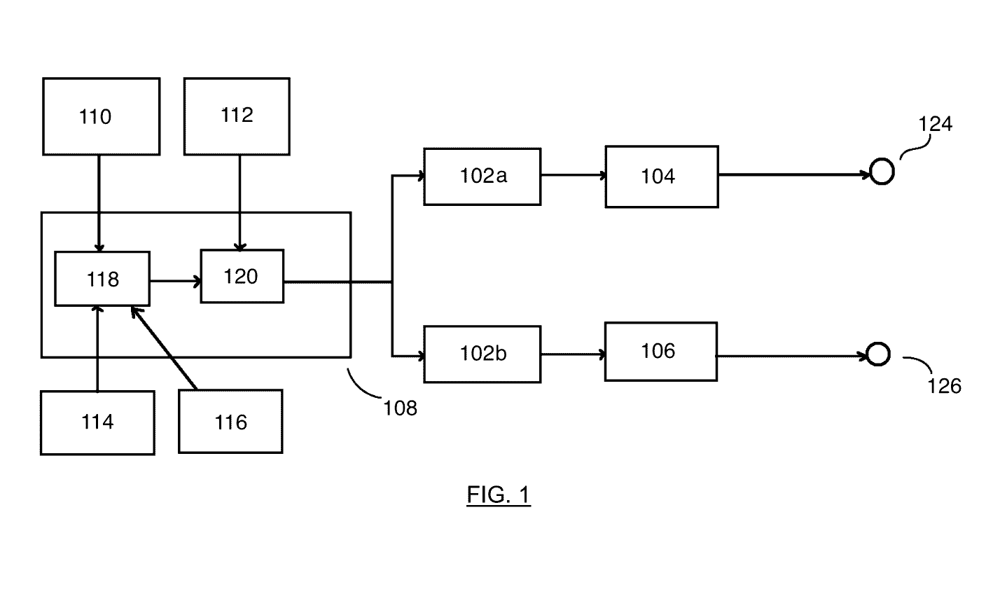

With reference to FIG. 1, according to one embodiment of the disclosure, methods of perforating a zone of multiple wellbores and stimulating the respective surrounding formation in an essentially simultaneous manner are provided. The subterranean formation areas of interest to be treated may be conventional reservoirs, or unconventional reservoirs (e.g., such as tight gas, shale, carbonate, coal, heavy oil, etc.). In the general surface arrangement, a pumping system 102 is fluidly connected with manifolds 104 and 106, as well as blending unit 108. At least one pumping system, 102a and/or 102b, may serve to transfer subterranean formation treatment fluid from blending unit 108 to manifolds 104 and 106. The treatment fluid may be prepared from constituents including, but not necessarily limited to, a liquid medium 110, proppant 112, chemicals 114, and optional polymer 116. Any suitable materials known to those of skill in the art may be used to prepare the treatment fluid, given the particular treatment requirements for specific well operations. Some non-limiting examples of such materials include viscoelastic surfactants, natural and derivatized polymers, synthetic polymers, crosslinkers, fibers, demulsifiers, corrosion inhibitors, friction reducers, clay stabilizers, scale inhibitors, biocides, breaker aids, mutual solvents, alcohols, surfactants, anti-foam agents, defoamers, viscosity stabilizers, iron control agents, diverters, emulsifiers, foamers, oxygen scavengers, pH control agents, acids, bases and buffers. The liquid medium 110 can be aqueous or non-aqueous, such as fresh water, produced water, saltwater, brine, diesel, and the like. The treatment fluid may be formulated based on the type formation stimulation desired, and the conditions of specific formation being treated, as well as liquid medium characteristics. The fluid can be gel (such as aqueous gel, gelled oil gelled gas), foam, energized fluid, slickwater, acid, gelled acid, emulsified acid, and the like.

The blending unit 108 may include a pre-blending unit 118 wherein the liquid medium 110, chemicals 114 and optional polymer 116 can be metered from their source and mixed together to form a pre-blend fluid. The pre-blend fluid may then be mixed with proppant 112 in mixer 120. In some stages of a well operation, a proppant free pad fluid may be pumped at pressure sufficient to initial a fracture in the subterranean formation zone of interest. Afterward, proppant may be added to the pre-blend fluid in mixer 120 to be placed in the fracture formed in the subterranean formation. In either case, the treatment fluid is delivered from mixer 120 to one or more pumping systems (102a and/or 102b), and then to pressure manifolds 104 and 106. Each of the pumping systems 102a and 102b may include any suitable number of pumps for delivering an adequate volume of fluid to the pressure manifolds, at a selected pressure. Pressure manifolds 104 and 106, which are essentially fluid pressurizing systems, each contain a low-pressure side for receiving the treatment fluid and a high pressure side for delivering the treatment fluid to one or more wellbores 124 and 126 respectively. The manifolds (also commonly referred to as ‘manifold trailers’) themselves are well known in the art. A line from each manifold can connect directly to one or more wellbores through a well head to deliver the treatment fluid downhole at pressure sufficient to fracture the subterranean formation. Any suitable number of pumps may be used in each pumping system to perform the operation by achieving target pressure and fluid delivery rate. Furthermore, connections made between the equipment components described may be a standard piping or any suitable tubing known to one of ordinary skill in the art. While two manifolds are shown in FIG. 1, it is within the spirit and scope of the disclosure that any suitable number of manifolds may be used, and in some cases, the number of manifolds may be equal to or less than the number of wellbores to receive pressurized treatment fluid. In some aspects, the operations for delivering liquid medium 110, chemicals 114, proppant 112, polymer 116, operating the blending unit 108, pumping units 102a, 102b, and manifolds 104 and 106 may be controlled, coordinated, and monitored by a central control system.

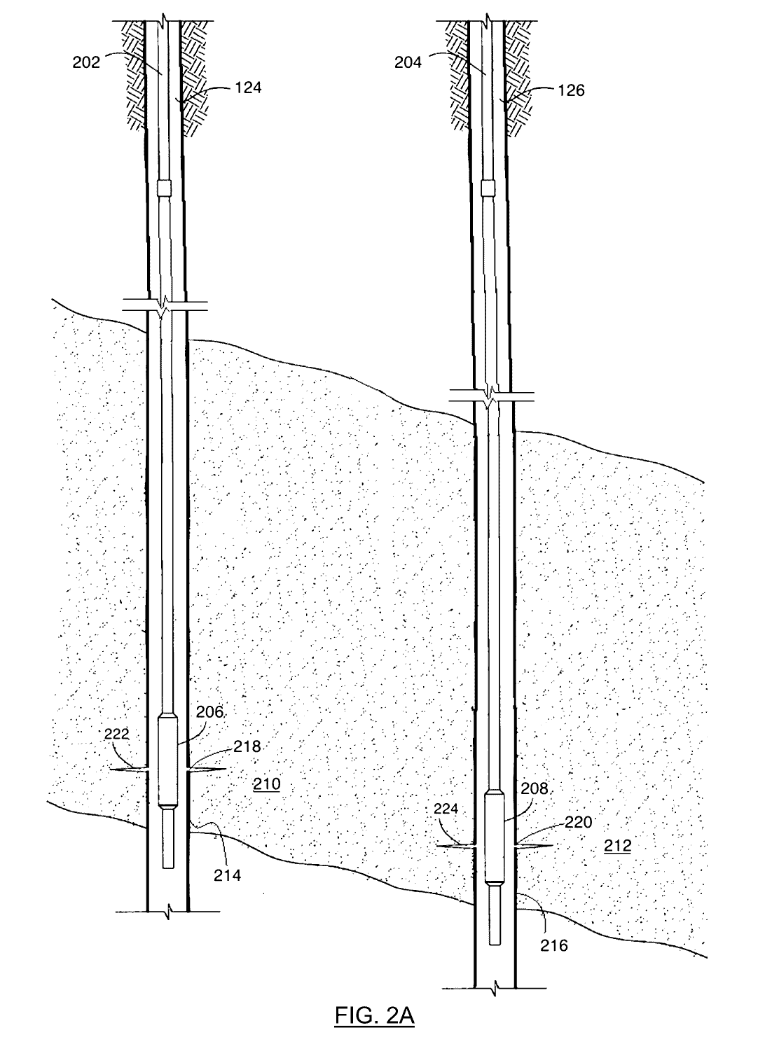

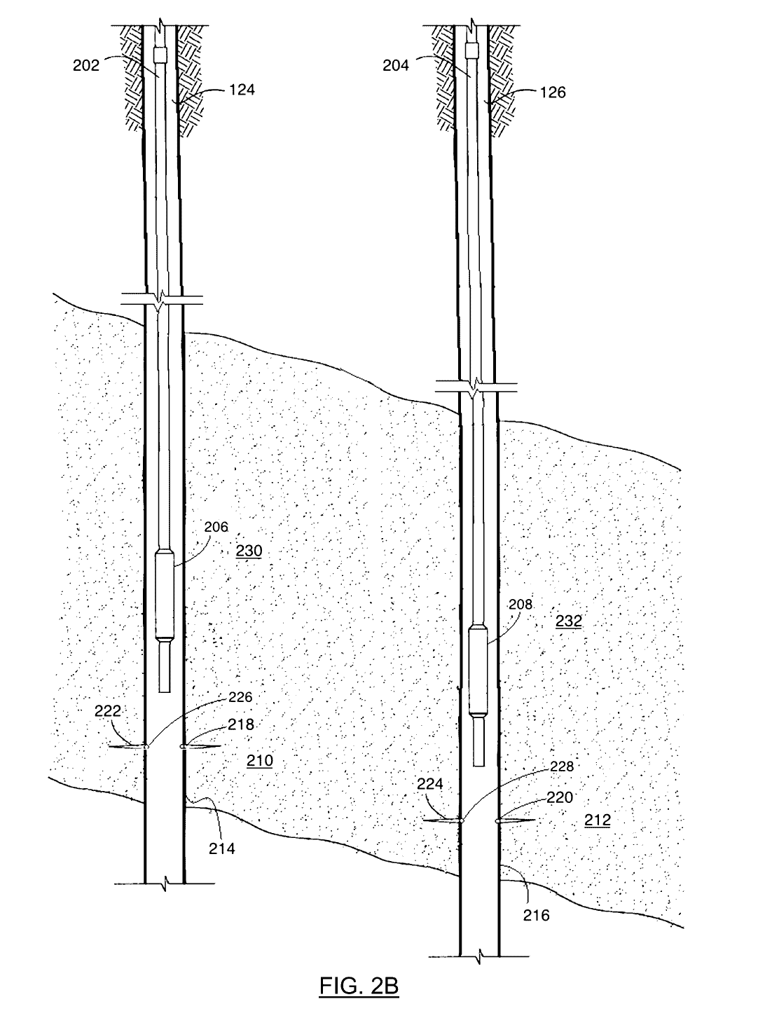

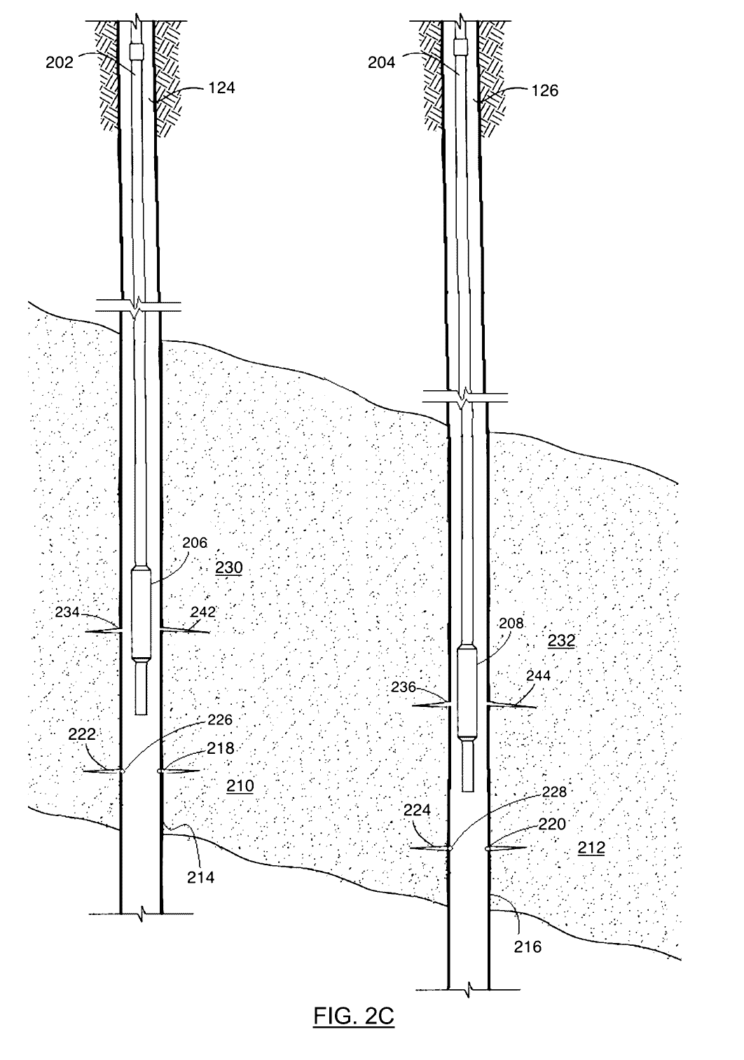

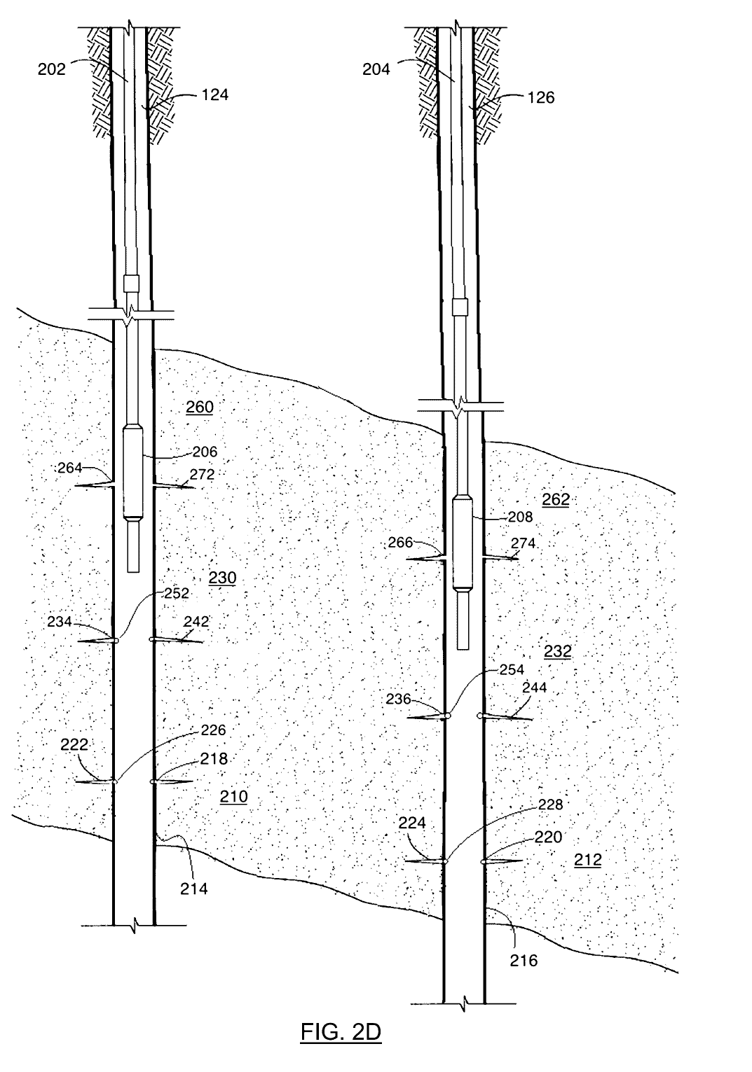

The arrangement depicted in FIG. 1 may be used in methods of treating a subterranean formation where there are a plurality of cased wellbores penetrating the subterranean formation, such as 124 and 126, using a common treatment fluid delivered by pumping units 102a and 102b, and treating the subterranean formation by pumping the treatment fluid through flow-through passages formed in the plurality of cased wellbores at a pressure sufficient to treat the subterranean formation. In some cases where more than one zone within one or more of the wellbores is to be treated, embodiments of the disclosure may be useful for treating a target zone within each wellbore simultaneously among more than one wellbore, or in any practical order as described below. Subterranean formation treatment simultaneous through more than one wellbore at a zone within each wellbore may be considered parallel treatments. Afterward, a next zone may be treated in each wellbore, and thereafter another zone, and repeated until Nth zone is treated within each of the wellbores. Such methodology may be advantageous to better ensure all zones within all wellbores are more effectively stimulated, while still allowing for multiple clusters to be treated simultaneously (such as on different wells rather than in multiple clusters in a single stage on a single well). FIGS. 2A-2D illustrate how such a treatment method may work in operation, in accordance with some aspects of the disclosure.

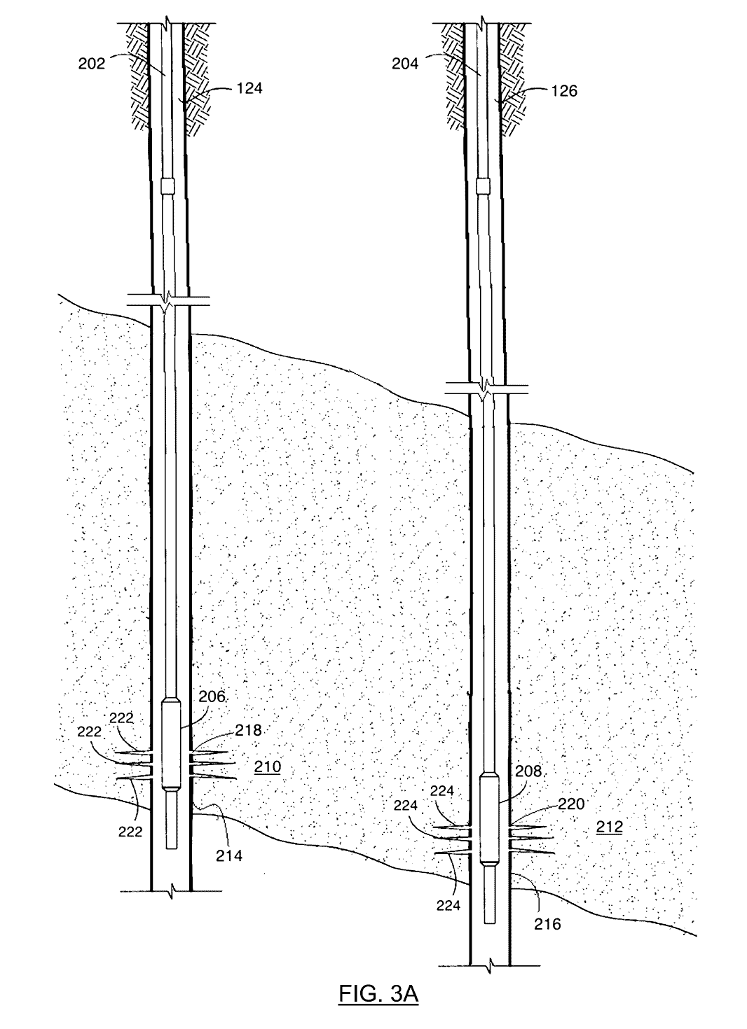

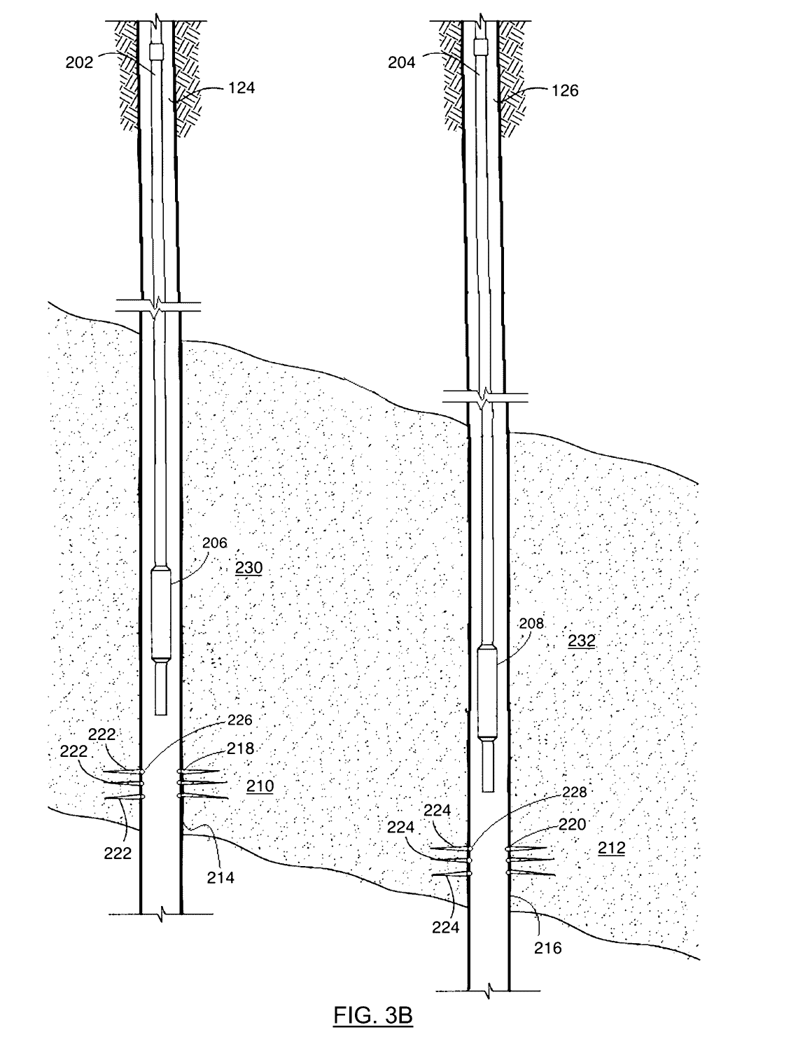

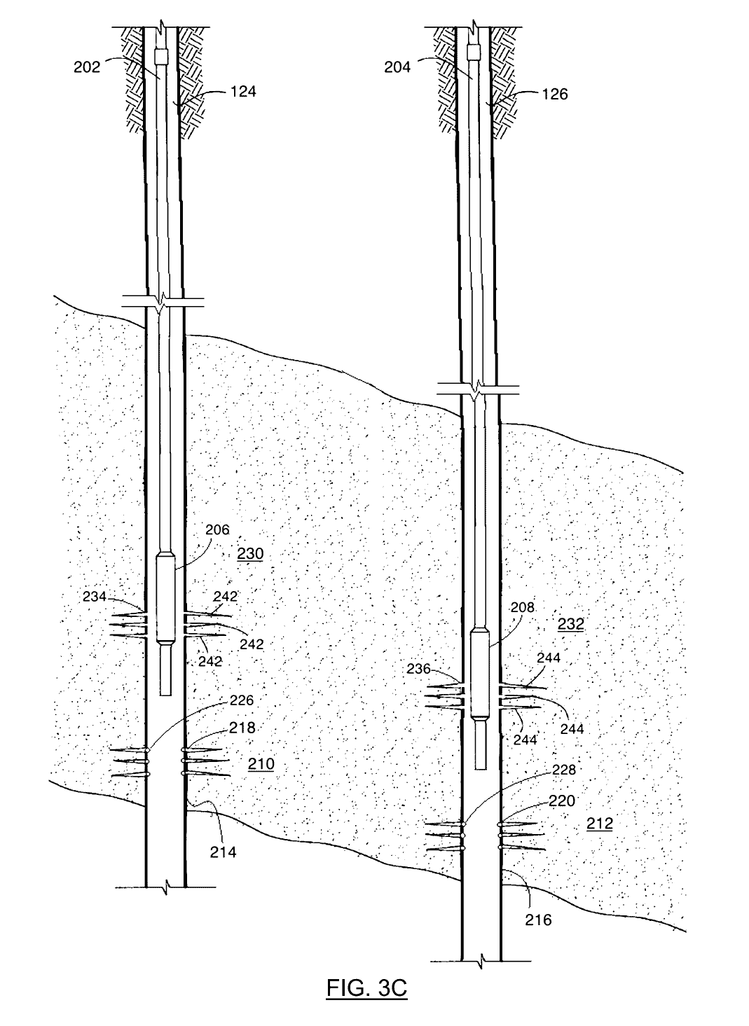

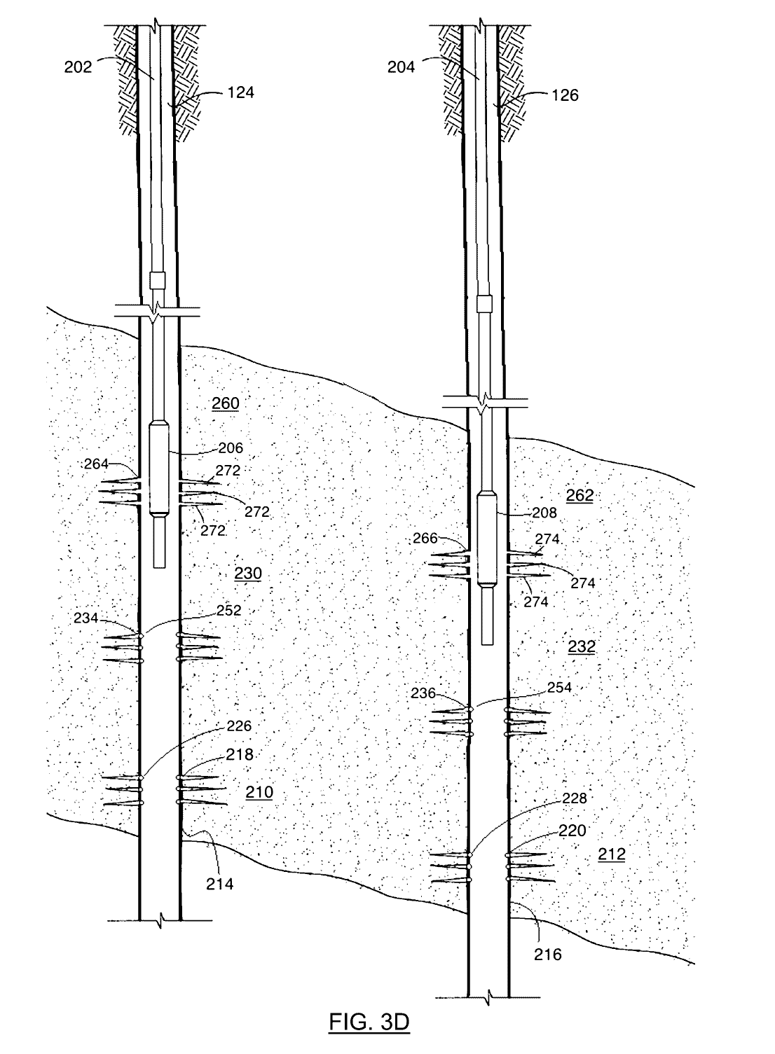

FIG. 2A illustrates a first stage of a treatment method in accordance with some embodiments of the disclosure. Tool strings 202 and 204 are moved into cased wellbores 124 and 126, respectively, and tools 206 and 208, conveyed on tool strings 202 and 204, are positioned adjacent to subterranean formation areas of interest 210 and 212. Tools 206 and 208 may include perforation guns, hydrojets, or any suitable device known in the art, to perforate wellbore casings 214 and 216, thus creating fluid passageways 218 and 220 in the casings (two shown in each casing). While one pair of passageways are depicted in a cluster throughout the FIGS. 2A-2D for maximum effectiveness, it is within the scope of the disclosure to have two pair of passageways, or any suitable number of passageways, such as three pair as depicted in FIGS. 3A-3D below, to further increase efficiency. The connection between the wellbore and reservoir could also be achieved by opening frac ports using coiled tubing shifting tools, dart drop or ball drop systems. Fluid passageways 218 and 220 establish fluid connections between cased wellbores 124 and 126, and formation areas of interest 210 and 212, respectively. Treatment fluid may then be introduced through wellbores 124 and 126, and fluid passageways 218 and 220, simultaneously, at pressures equal to or greater than the fracture initiation pressures of formation areas 210 and 212, to create fractures 222 and 224 at formation areas 210 and 212. Once fractures 222 and 224 are created and while remaining under fluid pressure adequate to maintain the open fractures, proppant may be added to the treatment fluid and thereafter introduced into the open fractures to help ensure the fractures remain open after the treatment operation is concluded and the wellbores begin producing formation fluid. Alternatively, acid can be used to etch the fracture faces in and ensure that the fractures remain open in carbonate formations. Fractures formed in accordance with the method embodiments of the disclosure may be formed in a well drilled in the direction of, aligned with, or in a plane parallel to a principal stress of the subterranean formation surrounding each of the wellbores.

Now referring to FIG. 2B, which depicts a second stage of a treatment method in accordance with some embodiments of the disclosure. Prior to treating a second set of subterranean formation areas of interest 230 and 232, in some instances, isolation of fractures 222 and 224 from wellbores 124 and 126 may be conducted. Such isolation may be made by any suitable technique or device known to those of skill in the art, such as packers, plugs, ball sealers, and the like. In FIG. 2B, ball sealers 226 (two shown) and 228 (two shown) are shown to isolate fractured formation areas 210 and 212. Ball sealers 226 and 228 are pumped into the wellbores 124 and 126, and plug fluid passageways 218 and 220, respectively, thereby isolating fractured formation areas 210 and 212 from wellbores 124 and 126. Also, tool strings 202 and 204 are moved within cased wellbores 124 and 126, to position tools 206 and 208 adjacent formation areas of interest 230 and 232.

As illustrated in FIG. 2C, wellbore casings 214 and 216 may then be perforated to create fluid passageways 234 and 236 adjacent formation areas 230 and 232. Fluid passageways 234 and 236 establish fluid connections between cased wellbores 124 and 126, and formation areas 230 and 232, respectively. In this second stage, similar with above, treatment fluid may then be introduced through wellbores 124 and 126, and fluid passageways 234 and 236, simultaneously. The fluid pressures may be equal to or greater than the fracture initiation pressures of formation areas 230 and 232, to create fractures 242 and 244. After forming fractures 242 and 244, and while remaining under fluid pressure adequate to keep fractures open, proppant may be added to the treatment fluid and introduced into the open fractures. While this second treatment is performed, fractured formation areas 210 and 212 may remain isolated from wellbores 124 and 126, and as depicted, with ball sealers 226 and 228.

In some aspects of the disclosure, yet another treatment may be conducted in another zone within the plurality of wellbores, simultaneously, to stimulate the adjacent subterranean formation. As illustrated in FIG. 2D, ball sealers 252 and 254 are shown to isolate fractured formation areas 230 and 232, by being pumped into the wellbores 124 and 126, and plug fluid passageways 234 and 236, thus isolating fractured formation areas 230 and 232 from wellbores 124 and 126. Tool strings 202 and 204 are moved within cased wellbores 124 and 126, to position tools 206 and 208 adjacent formation areas of interest 260 and 262. Wellbore casings 214 and 216 may then be perforated at this third zone to create fluid passageways 264 and 266, adjacent formation areas 260 and 262 and connecting cased wellbores 124 and 126 therewith. In this third stage, similar with above, treatment fluid may then be introduced through wellbores 124 and 126, and fluid passageways 264 and 266, simultaneously, at pressures equal to or greater than the fracture initiation pressures of formation areas 260 and 262. Fractures 272 and 274 are formed in formation areas 260 and 262, respectively, and after fracture formation, with fluid pressure adequate to keep fractures open, proppant may be added to the treatment fluid and introduced into the open fractures 272 and 274. While this third treatment is performed, fractured formation areas 210, 212, 230 and 232 may remain isolated from wellbores 124 and 126 with ball sealers 218, 220, 252 and 254.

The above process may be conducted any number of occurrences to achieve the intended overall subterranean formation treatment. For example, the staged simultaneous parallel treatment may be conducted in one, two, five, ten, twenty, or generally, Nth separate zones through fluid passageways formed in a plurality of cased wellbores, and the number of zones is not limiting upon embodiments of the disclosure. Also, while two wellbores are shown in FIGS. 2A-2D, the parallel subterranean formation treatments may be conducted through any number of wellbores, given the equipment, materials availability and the physical properties of the formation areas to be treated. In the above example, two clusters are treated simultaneously (one in first well and one in a second well) each with essentially 100% effectiveness, while retaining the same efficiency if two clusters would have been treated per stage in a single well, which would have given only about 39% effectiveness. Methods according to the disclosure are useful to fracture and stimulate multiple stages in a single continuous operation, and may be performed on cemented and un-cemented cased wellbores, which may be vertical, deviated, and horizontal in orientation. Also, embodiments according to the disclosure may be used both for onshore and offshore operations using existing or specialized equipment or a combination of both.

Now referencing FIGS. 3A through 3D, which together depict a treatment method in accordance with some other embodiments of the disclosure, where three pair of passageways is opened per cluster. FIG. 3A depicts, similar to above, a first stage, where tool strings 202 and 204 are moved into wellbores 124 and 126, respectively, and positioned adjacent to subterranean formation areas of interest 210 and 212. Fluid passageways 218 and 220 are opened to establish fluid connections between cased wellbores 124 and 126, and formation areas of interest 210 and 212. Treatment fluid may then be introduced through wellbores 124 and 126, and fluid passageways 218 and 220, simultaneously, at pressures equal to or greater than the fracture initiation pressures of formation areas 210 and 212, to create fractures 222 and 224 at formation areas 210 and 212, and then place proppant therein. In some cases, acid may be used to etch the fracture faces in and ensure that the fractures remain open in carbonate formations. Fractures formed in accordance with the method embodiments of the disclosure may be formed in a well drilled in the direction of, aligned with, or in a plane parallel to a principal stress of the subterranean formation surrounding each of the wellbores.

FIG. 3B shows a second stage, where prior to treating a second set of subterranean formation areas of interest 230 and 232, isolation of fractures 222 and 224 from wellbores 124 and 126 is conducted. In FIG. 3B, ball sealers 226 (six shown) and 228 (six shown) isolate fractured formation areas 210 and 212. Also, tool strings 202 and 204 are moved within cased wellbores 124 and 126, to position tools 206 and 208 adjacent formation areas of interest 230 and 232. FIG. 3C illustrates wellbore casings 214 and 216 perforated to create fluid passageways 234 and 236 adjacent formation areas 230 and 232. Fluid passageways 234 and 236 establish fluid connections between cased wellbores 124 and 126, and formation areas 230 and 232, respectively. In this second stage, treatment fluid may then be introduced through wellbores 124 and 126, and fluid passageways 234 and 236, simultaneously. The fluid pressures may be equal to or greater than the fracture initiation pressures of formation areas 230 and 232, to create fractures 242 and 244. After forming fractures 242 and 244, and while remaining under fluid pressure adequate to keep fractures open, proppant may be added to the treatment fluid and introduced into the open fractures. While this second treatment is performed, fractured formation areas 210 and 212 may remain isolated from wellbores 124 and 126 with ball sealers 226 and 228.

FIG. 3D shows a next stage where ball sealers 252 and 254 isolate fractured formation areas 230 and 232 by plugging fluid passageways 234 and 236. Tool strings 202 and 204 are moved within cased wellbores 124 and 126, to position tools 206 and 208 adjacent formation areas of interest 260 and 262. Wellbore casings 214 and 216 may then be perforated at this third zone to create fluid passageways 264 and 266. In this third stage, similar with above, treatment fluid may then be introduced through wellbores 124 and 126, and fluid passageways 264 and 266, simultaneously, at pressures equal to or greater than the fracture initiation pressures of formation areas 260 and 262. Fractures 272 and 274 are formed in formation areas 260 and 262, respectively, and after fracture formation, with fluid pressure adequate to keep fractures open, proppant may be added to the treatment fluid and introduced into the open fractures 272 and 274. While this third treatment is performed, fractured formation areas 210, 212, 230 and 232 may remain isolated from wellbores 124 and 126 with ball sealers 218, 220, 252 and 254.

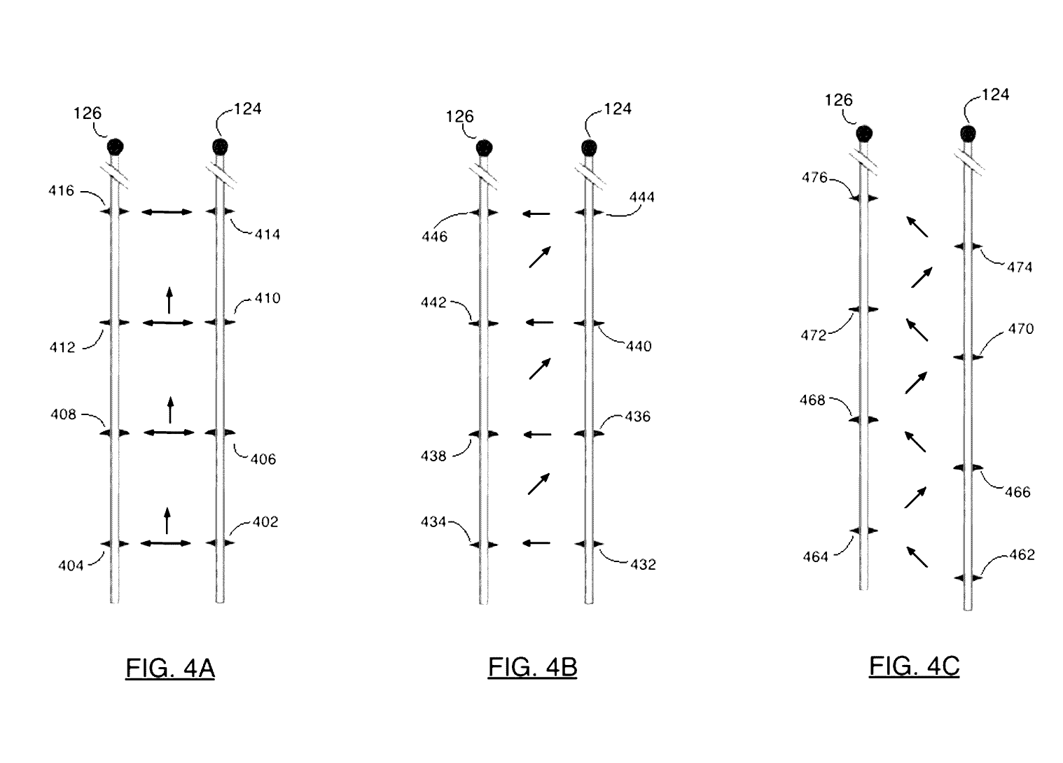

Method embodiments according to the disclosure can be used to treat any number of a plurality of wellbores, and formation of flow-through passages and treatments may be conducted in any practical order. FIGS. 4A-4C illustrate some examples of the order of forming flow-through passages and conducting subterranean formation treatment. In FIGS. 4A-4C two wells are shown drilled, cased, then a pair of perforations is created and subterranean formation treated. FIG. 4A illustrates wellbores 124 and 126 being simultaneously treated after perforating to form fractures 402 and 404. Then, the next zone of interest is simultaneously treated in both wellbores, after perforating, to form fractures 406 and 408. Fractures 410 and 412 are formed thereafter, and then fractures 414 and 416, in like manner.

FIG. 4B depicts the treatment order in sequential fracturing (such as “zipper-frac”). In sequential fracturing, after two or more parallel wells are drilled and cased, perforation and treatment are conducted at alternate intervals along the well bores. This approach may be used to create a high-density network of fractures between the wells that may enable increasing production in both wells. By holding fracturing fluid pressure on one well while the adjacent well is being fractured, the fractures may tend to avoid each other due to the stress pattern set up in the pressured-up well, which may provide a maximum of new reservoir rock exposed. As depicted in FIG. 4B, fracture 432 is created from wellbore 124, and then fracture 434 from wellbore 126. Afterward, separately in order while maintaining pressures, fractures 436, 438, 440, 442, 444 and 446 are formed. FIG. 4C illustrates a modified sequential fracturing order (such as a “modified zipper-frac”) where the sequential stimulation is performed similar to that depicted in FIG. 4B, but in offsetting stages relative a plane parallel with the horizon or at different wellbore depths, which may be used to further enhance the fracturing of the natural fractures. As shown in FIG. 4C, fracture 462 is formed from wellbore 124, then 464 from wellbore 126. Afterward, separately in order while maintaining adequate fluid pressures, fractures 466, 468, 470, 472, 474 and 476 are formed in like manner.

In comparison with traditional multiple zone treatments, conducted in series within a given wellbore, embodiments of the disclosure split the treatment fluid volume delivery rate among a plurality of zones in different wellbores, thus treating a single zone within each of the wellbores with improved accuracy and reliability. To illustrate, if the overall common treatment fluid delivery rate is 100 barrels per minute, and 4 wellbores receive the treatment fluid simultaneously, then 25 barrels per minute may be available for each wellbore. Also, in some aspects, the treatment fluid delivery rate could vary for each wellbore, and be specifically tailored for each, such as 18 barrels per minute for a first wellbore, 20 barrels per minute for another, 22 for another wellbore, 35 for another and 25 for a last wellbore. As such, any suitable treatment fluid delivery rate may be used in the particular wellbores. Further, multiple staged treatments within a wellbore may be conducted in any suitable order of zonal positions within each wellbore, and not necessarily from the bottom toward the surface, as illustrated in FIGS. 2A-2D, 3A-3D and 4A-4C. In some aspects, the order of treatment may be selected based upon the fracture initiation pressure of the formation surrounding the wellbore, and may, for example, proceed from higher fracture initiation pressure to lower.

Referring again to FIGS. 2A-2D and 3A-3D, tools 206 and 208 are depicted as conveyed through cased wellbores 124 and 126 by tool strings 202 and 204. However, any suitable means of conveyance may be used in embodiments of the disclosure, including, but not limited to wireline cable, wireline tractor, well shuttle, coiled tubing, pipe string, and the like. Also, fluid passageways may be formed by any suitable technique, for example, bullet guns, abrasives, water jets, shaped charges, pre-perforated casings with dissolvable plugs, or other techniques readily known to those of skill in the art.

Methods embodiments may further include modeling the overall treatment. In some cases, subterranean formation layer geomechanical properties including well completion and reservoir data for the subterranean formation, and a natural fracture network description for the subterranean formation are acquired, then inputted into a model. Propagation of a network of fractures in the subterranean formation is simulated and fracture growth and branching is predicted. Flow rate and pressure distribution throughout the network of fractures is then predicted by solving governing deformation and flow equations, and a simulated result of a design for the treating the subterranean formation is provided. Flow-through passages are formed in a casing at a first zone within each wellbore of the plurality of cased wellbores, and the plurality of cased wellbores are fluidly connected with a common treatment fluid source. The subterranean formation is then treated by pumping the common treatment fluid through the flow-through passages formed in the plurality of cased wellbores at a pressure sufficient to treat the subterranean formation. The treatment design may then be modified if the result is not satisfactory. If required, the next zone may then be treated per the original treatment design, or as necessary, a modified design. Modeling techniques, such as those disclosed in U.S. Patent Application Publications 20120185225A1, 20120179444A1, 20140222405A1, 20130066617A1 and 20140136173A1, as well as U.S. Pat. No. 8,412,500, all of which are incorporated herein in their entirety, may also be useful in some embodiments where modeling the treatment is a component of the overall treatment.

In some aspects, treating one cluster at a time per wellbore may also provide benefits in subterranean formations with complex geomechanics, such as those described in Lecampion et al., “Can We Engineer Better Multistage Horizontal Completions? Evidence of the Importance of Near-wellbore Fracture Geometry from Theory, Lab and Field Experiments”, Society of Petroleum Engineers, 2015, SPE 173363 (incorporated herein by reference), or even in subterranean environments where there is a strong heterogeneity in either rock fabric or in situ stresses along the wellbore path resulting in heterogeneity in near-wellbore friction. In instances where there is a subterranean formation with complex geomechanics, an objective may be to simultaneously place a number of fractures in a given stage, as well as a similar amount of proppant in each fracture. In such circumstances, fluid partitioning between fractures within a stage is a quantity to be solved for, and not necessarily assumed the same in all fractures. It is part of the complete solution where wellbore flow dynamics, hydraulic fracture initiation, propagation and interaction are tightly coupled. From numerical modeling, it is possible to counteract stress interaction between fractures by increasing entry friction sufficiently, such as when the local pressure drop at the wellbore-fracture connection is larger than the interaction stress. Thus, a combination of engineered staging (moving cluster location to minimize the stress difference between them) and engineered limited entry (further choking down the clusters in the lower stress zone) may allow a homogeneous partitioning of the fluid between the different fractures.

In some other embodiments, modeling and execution of the treatment operation includes use of elasticity properties for each of the subterranean formations. In such cases elasticity properties are input into a model for each of the subterranean formations surrounding each wellbore of the plurality of wellbores, and propagation of a network of fractures is simulated in each of the subterranean formations. Flow rate and pressure distribution throughout the network of fractures is then predicted by solving governing deformation and flow equations, and an optimum common treatment fluid is formulated and prepared to achieve the simulated fracturing result. Flow-through passages are formed in a casing at a first zone within each wellbore of the plurality of cased wellbores, and the plurality of cased wellbores are fluidly connected with a common treatment fluid source. The subterranean formation is then treated by pumping the common treatment fluid through the flow-through passages formed in the plurality of cased wellbores at a pressure sufficient to treat the subterranean formation. The treatment of each formation area is conducted in a direction aligned with or in a plane parallel to a direction of a principal stress of the subterranean formation surrounding each wellbore making up the plurality of wellbores. The treatment design may then be modified if the result is not satisfactory. A next zone may then be treated per the original treatment design, or as necessary, a modified design.

Another method in accordance with the disclosure is a method of fracturing a naturally fractured subterranean formation which includes using a model based upon formation layer geomechanical properties, well completion and reservoir data for the subterranean formation, as well as a natural fracture network description for the subterranean formation. The fracture treatment is modeled by inputting data acquired that simulates propagation of a network of fracture branches by dividing fracture segments into a plurality of elements to form a fracture grid. Each element is described by a model which may be one of a Perkins-Kern-Nordgren (2D PKN) model, a pseudo-3D model, planar 3D model, a Kristianovich-Geertsma-de Klerk (KGD) model, a radial model, wiremesh model, unconventional fracturing model, or any appropriate model for hydraulic fracturing fractured reservoirs. An optimum fracture fluid composition may be formulated and prepared, as well as the fracture treatment design to achieve the fracturing objective. A first cluster of perforations are formed at a first zone within each wellbore of the plurality of cased wellbores, and the subterranean formation is fractured by simultaneously pumping the optimum fracture fluid composition through the first cluster of perforations at a pressure sufficient to fracture the subterranean formation adjacent each wellbore. As required, the fluid composition and/or design may be adjusted if the predicted result is not satisfactory, or may be further improved in the following stages of treatment.

In yet another embodiment, methods include modeling and fracturing, where modeling is achieved by generating a plurality of quality indicators from a plurality of logs, combining the plurality of quality indicators to form a composite quality indicator, then combining the composite quality indicator with a stress log to form a combined stress and composite quality indicator, the combined stress and composite quality indicator including a plurality of blocks with boundaries there between. Classifications are identified for the plurality of blocks, and stages defined along the combined stress and composite quality indicator based on the classifications. Then flow-through passages are formed at a first zone within each wellbore of a plurality of cased wellbores wherein the flow-through passages are selectively positioned based on the classifications. The subterranean formation is then fractured by simultaneously pumping a fracturing fluid through the flow-through passages at a pressure sufficient to fracture the subterranean formation adjacent each wellbore.

In another embodiment, methods include modeling and fracturing, where the modeling is conducted using a “cube” three dimensional volume model, such as a volume within a geomodel as disclosed in PCT Patent Application Publication WO2015006363A1, which is incorporated by reference herein in its entirety. In some aspects, the “cube” model includes receiving a three-dimensional model of a subterranean volume that includes a reservoir, then determining, using a processor, one or more hydraulic fracture performance attributes of the subterranean volume based in part on the model. A completion quality is then determined for one or more locations in the subterranean volume based at least in part on the one or more hydraulic fracture performance attributes.

In some aspects, use of modeling techniques as part of the overall operation provides a design tool to predict the dimensions and the structure of the created fracture system in a naturally fractured formation to achieve the optimal well productivity. The models that predict subterranean formation treatment, may also include such methods as treatment fluid design, breaker schedule design, rheology representation in treatment simulators, and the like. Further, the modeling may be used to design an overall zone perforation and treatment sequence, within each wellbore, to form an optimum fracture network throughout the subterranean formation penetrated by the multiple wellbores.

The modeling technique, in some cases, may be provided as a tool which is part of the surface equipment of the wellsite for performing stimulation operations. For example, information generated during one or more of the stimulation operations may be used in formation treatment planning for the plurality of wellbores, and formation surrounding the treatment zones adjacent. The modeling tool may be operatively linked to one or more rigs and/or wellsites, and used to receive data, process data, send control signals, etc. In some cases, the modeling tool may include any one or more of a reservoir characterization unit for generating a mechanical earth model (MEM), a stimulation planning unit for generating stimulation plans, an optimizer for optimizing the stimulation plans, a real time unit for optimizing in real time the optimized stimulation plan, a control unit for selectively adjusting the stimulation operation based on the real time optimized stimulation plan, an updater for updating the reservoir characterization model based on the real time optimized stimulation plan and post evaluation data, and a calibrator for calibrating the optimized stimulation plan. The modeling tool may include a staging design component for performing staging design, a stimulation component for performing stimulation design, a production prediction component for predicting production and a well planning component for generating well plans.

While only simplified wellsite and wellbore configurations are shown in the figures, it will be appreciated that the wellsite may cover a portion of land, sea and/or water locations that hosts a plurality of wellbores, as described above. Production may also include injection wells (not shown) for added recovery or for storage of hydrocarbons, carbon dioxide, or water, for example. One or more gathering facilities may be operatively connected with the wellbores for selectively collecting downhole fluids from the wellbores.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method of treating a subterranean formation, the method comprising:
(a) providing a plurality of cased wellbores penetrating the subterranean formation, wherein the plurality of cased wellbores are fluidly connected with a common treatment fluid source;
(b) forming flow-through passages at a first zone within each wellbore comprised in the plurality of cased wellbores; and,
(c) pumping a treatment fluid through the flow-through passages formed in the plurality of cased wellbores at a pressure sufficient to treat the subterranean formation.

2. The method of claim 1 wherein the flow-through passages are a cluster of perforations.

3. The method of claim 1 wherein the flow-through passages are multistage completion frac ports.

4. The method of claim 1 wherein a fluid pressurizing system is disposed between each of the wellbores and the common treatment fluid source.

5. The method of claim 4 wherein each of the wellbores is fluidly connected with a dedicated fluid pressurizing system for delivering treatment fluid from the common treatment fluid source to each of the wellbores at a select fluid pressure.

6. The method of claim 5 wherein the pressure of the treatment fluid in each wellbore is equal to or greater than the fracture initiation pressure of the subterranean formation surrounding each of the plurality of cased wellbores.

7. The method of claim 1 wherein the treating fluid is one of a gel, slickwater, energized fluids, foam, acid, gelled acid, emulsified acid, or chelating agent.

8. The method of claim 6, wherein the treating is conducted in a well drilled in the direction perpendicular to a principal stress of the subterranean formation surrounding each wellbore comprised in the plurality of cased wellbores.

9. The method of claim 6, wherein the treating is conducted in a well drilled in the direction aligned with or in a plane parallel to a direction of a principal stress of the subterranean formation surrounding each wellbore comprised in the plurality of wellbores.

10. The method of claim 1 wherein the flow-through passages are formed by at least one of a perforating gun, by jetting and by forming holes in each wellbore.

11. The method of claim 1 wherein the flow-through passages are formed by at least one coiled tubing actuation, dart drop or ball drop to open frac ports in each wellbore.

12. The method of claim 1 further comprising:
(d) forming second flow-through passages at a second zone within each wellbore comprised in the plurality of cased wellbores, and plugging the flow-through passages formed in step b); and,
(e) pumping the treatment fluid through the second flow-through passages formed at the second zone at a pressure sufficient the treat the subterranean formation.

13. The method of claim 12 further comprising:
(f) forming Nth flow-through passages at an Nth zone within each wellbore comprised in the plurality of cased wellbores, and plugging the flow-through passages formed in step d); and,
(g) pumping the treatment fluid through the Nth flow-through passages formed at the Nth zone at a pressure sufficient the treat the subterranean formation.

14. The method of claim 1 further comprising:
(i) acquiring subterranean formation layer geomechanical properties comprising well completion and reservoir data for the subterranean formation, and a natural fracture network description for the subterranean formation;
(ii) inputting geomechanical properties of the subterranean formation into a model;
(iii) simulating propagation of a network of fractures in the subterranean formation;
(iv) predicting if each fracture will grow and in which direction the fracture will branch;
(v) predicting a flow rate and pressure distribution throughout the network of fractures by solving governing deformation and flow equations;
(vi) predicting a result of a design for the treating the subterranean formation;
(vii) performing (b) and (c);
(viii) adjusting the design if the predicted result is not satisfactory; and,
(ix) adjusting stage location and treatment size to optimize reservoir contact if results are not satisfactory.

15. The method of claim 1 further comprising:
(i) inputting elasticity properties into a model for each of subterranean formation surrounding each wellbore comprised in the plurality of wellbores;
(ii) simulating propagation of a network of fractures in each of the subterranean formations;
(iii) predicting if each fracture will grow and in which direction the fracture will branch;
(iv) predicting a flow rate and pressure distribution throughout the network of fractures by solving governing deformation and flow equations;
(v) preparing an optimum treatment fluid to achieve simulated fracturing result; and,
(vi) performing (b) and (c);
wherein the treating is conducted in a direction aligned with or in a plane parallel to a direction of a principal stress of the subterranean formation surrounding each wellbore comprised in the plurality of wellbores.

16. A method comprising:
(a) providing a plurality of cased wellbores penetrating the subterranean formation, wherein the plurality of cased wellbores are fluidly connected with a common fracturing fluid source;
(b) forming a first cluster of perforations at a first zone within each wellbore comprised in the plurality of cased wellbores; and,
(c) fracturing the subterranean formation by simultaneously pumping a fracturing fluid through the first cluster of perforations at a pressure sufficient to fracture the subterranean formation adjacent each wellbore.

17. The method of claim 16, wherein each of the wellbores is fluidly connected with a dedicated fluid pressurizing system for delivering fracturing fluid from the common fracturing fluid source to the wellbore at a select fluid pressure.

18. The method of claim 17, wherein the fracturing is conducted in a direction aligned with or in a plane parallel to a direction of a principal stress of the subterranean formation surrounding each wellbore comprised in the plurality of wellbores.

19. The method of claim 16 further comprising:
(d) forming a second cluster of perforations at a second zone within each wellbore comprised in the plurality of cased wellbores; and,
(e) fracturing the subterranean formation by simultaneously pumping the fracturing fluid through the second cluster of perforations formed at the second zone at a pressure sufficient the fracture the subterranean formation.

20. The method of claim 19 further comprising:
(f) forming an Nth cluster of perforations at a Nth zone within each wellbore comprised in the plurality of cased wellbores; and,
(e) fracturing the subterranean formation by simultaneously pumping the fracturing fluid through the Nth cluster of perforations formed at the Nth zone at a pressure sufficient the fracture the subterranean formation.

21. The method of claim 16 further comprising:
(i) acquiring subterranean formation layer geomechanical properties comprising well completion and reservoir data for the subterranean formation, and a natural fracture network description for the subterranean formation;
(ii) inputting geomechanical properties of the subterranean formation into a model;
(iii) simulating propagation of a network of fractures in the subterranean formation;
(iv) predicting if each fracture will grow and in which direction the fracture will branch;
(v) predicting a flow rate and pressure distribution throughout the network of fractures by solving governing deformation and flow equations;
(vi) predicting a result of a design for the fracturing the subterranean formation;
(vii) performing (b) and (c); and,
(viii) adjusting the design if the predicted result is not satisfactory.

22. The method of claim 16 further comprising:
(i) inputting elasticity properties into a model for each subterranean formation surrounding each wellbore comprised in the plurality of wellbores;
(ii) simulating propagation of a network of fractures in each of the subterranean formations;
(iii) predicting if each fracture will grow and in which direction the fracture will branch;
(iv) predicting a flow rate and pressure distribution throughout the network of fractures by solving governing deformation and flow equations;
(v) preparing an optimum treatment fluid to achieve simulated fracturing result; and,
(vi) performing (b) and (c);
wherein the treating is conducted in a direction aligned with or in a plane parallel to a direction of a principal stress of the subterranean formation surrounding each wellbore comprised in the plurality of wellbores.

23. A method of fracturing a naturally fractured subterranean formation, the method comprising:
(a) acquiring subterranean formation layer geomechanical properties, well completion and reservoir data for the subterranean formation, and a natural fracture network description for the subterranean formation;
(b) simulating a fracture treatment for the formation, the simulation comprising inputting data acquired into a model which simulates propagation of a network of fracture branches by dividing fracture segments into a plurality of elements to form a fracture grid, wherein each element is described by a model selected from the group consisting of a Perkins-Kern-Nordgren (2D PKN) model, a pseudo-3D model, planar 3D model, a Kristianovich-Geertsma-de Klerk (KGD) model, a three dimensional volume model, a radial model, wiremesh model, and an unconventional fracturing model;
(c) determining and preparing an optimum fracture fluid composition and/or fracture treatment design to achieve the fracturing objective;
(d) providing a plurality of cased wellbores penetrating the subterranean formation, wherein the plurality of cased wellbores are fluidly connected with a common fracturing fluid source;
(e) forming a first cluster of perforations at a first zone within each wellbore comprised in the plurality of cased wellbores;
(f) fracturing the subterranean formation by pumping the optimum fracture fluid composition through the first cluster of perforations at a pressure sufficient to fracture the subterranean formation adjacent each wellbore; and,
(g) adjusting the fluid composition and/or design if the predicted result is not satisfactory.

24. The method of claim 23 further comprising:
(h) forming second cluster of perforations at a second zone within each wellbore comprised in the plurality of cased wellbores;
(i) fracturing the subterranean formation by pumping a fracturing fluid through the second cluster of perforations formed at the second zone at a pressure sufficient the fracture the subterranean formation; and,
(j) adjusting the fluid composition and/or design if the predicted result is not satisfactory.

25. The method of claim 24 further comprising:
(k) forming Nth cluster of perforations at a Nth zone within each wellbore comprised in the plurality of cased wellbores;
(l) fracturing the subterranean formation by pumping a fracturing fluid through the Nth cluster of perforations formed at the Nth zone at a pressure sufficient the fracture the subterranean formation; and,
(m) adjusting the fluid composition and/or design if the predicted result is not satisfactory.

26. A method of fracturing a subterranean formation, the method comprising:
(a) generating a plurality of quality indicators from a plurality of logs;
(b) combining the plurality of quality indicators to form a composite quality indicator;
(c) combining the composite quality indicator with a stress log to form a combined stress and composite quality indicator, the combined stress and composite quality indicator comprising a plurality of blocks with boundaries therebetween;
(d) identifying classifications for the plurality of blocks;
(e) defining stages along the combined stress and composite quality indicator based on the classifications;
(f) providing a plurality of cased wellbores penetrating the subterranean formation, wherein the plurality of cased wellbores are fluidly connected with a common fracturing fluid source;
(g) forming flow-through passages at a first zone within each wellbore comprised in the plurality of cased wellbores, wherein the flow-through passages are selectively positioned based on the classifications; and,
(h) fracturing the subterranean formation by pumping a fracturing fluid composition through the flow-through passages at a pressure sufficient to fracture the subterranean formation adjacent each wellbore.

27. The method of claim 26 further comprising:
(i) forming second flow-through passages at a second zone within each wellbore comprised in the plurality of cased wellbores, wherein the second flow-through passages are selectively positioned based on the classifications; and,
(j) fracturing the subterranean formation by pumping the fracturing fluid through the second flow-through passages formed at the second zone at a pressure sufficient the treat the subterranean formation.

28. The method of claim 27 further comprising:
(k) forming Nth flow-through passages at an Nth zone within each wellbore comprised in the plurality of cased wellbores, wherein the Nth flow-through passages are selectively positioned based on the classifications; and,
(l) fracturing the subterranean formation by pumping the fracturing fluid through the Nth flow-through passages formed at the Nth zone at a pressure sufficient the treat the subterranean formation.
